(19) United States
(12) Patent Application Publication
(10) Pub. No.: US 2024/0282132 A1
(43) Pub. Date: Aug. 22, 2024

(54) METHOD AND SYSTEM FOR AUTO-LABELING DVS FRAMES

(71) Applicant: Harman International Industries, Incorporated, Stamford, CT (US)

(72) Inventor: Rengao ZHOU, Shanghai (CN)

(21) Appl. No.: 18/574,150

(22) PCT Filed: Jul. 7, 2021
(86) PCT No.: PCT/CN2021/104979

§ 371 Date: Dec. 26, 2023

(51) Int. Cl. G06V 20/70; G06V 10/70

(52) U.S. Cl. CPC G06V 20/70; G06V 10/70

(57) ABSTRACT

The disclosure provides a method and a system for auto-labeling dynamic vision sensor (DVS) frames. The method may comprise generating a plurality of first frames in a first time period via a DVS which is recording a real scene, wherein light is supplemented to an area where the DVS is recording, in the first time period. The method may comprise applying a deep leaning model to at least one of the plurality of first frames to obtain at least one first detection result. Further, the method may comprise generating a plurality of second frames in a second time period via the DVS, wherein no light is supplemented to the area where the DVS is recording, in the second time period. The method may further comprise utilizing the first detection result for one of the plurality of second frames to generate an auto-labeled DVS frame.

### TECHNICAL FIELD

The present disclosure relates to a method and system for auto-labeling, and specifically relates to a method and system for auto-labeling DVS (Dynamic Vision Sensor) frame by supplementing lights.

### BACKGROUND

In recent years, the DVS which is a new cutting-edge sensor, has become widely known and used in many fields, such as artificial intelligence field, computer vision field, auto-driving field, robotics, etc.

Compared to the conventional camera, the DVS has advantages on low-latency, no motion blur, high dynamic range, and low power consumption. Particularly, the latency for DVS is in microsecond while the latency for conventional camera is in millisecond. Consequently, the DVS is not suffering from motion blur. And as a result, the data rate of DVS is usually 40˜180 KB/s (for conventional camera, it is usually 10 mB/s), which means fewer bandwidth and fewer power consumption are needed. What's more, the dynamic range of DVS is about 120 dB while the dynamic range of conventional camera is about 60 dB. A wider dynamic range will be useful under extreme light conditions, for example, vehicle entering and exiting the tunnel, other vehicles in opposite direction turning on the high beam, sunshine direction changing, and so on.

Due to these advantages, DVS has been widely used. Currently, the deep learning method has been popular over different areas. The deep learning would also be suitable for the DVS, in various fields like object recognizing, segmentation, and so on. In order to apply the deep learning, a huge amount of labeled data is a necessity. However, since the DVS is a new kind of sensor, there is only a few labeled datasets available. And labeling the DVS datasets by hands is quite a task that requires a lot of resources and efforts. Thus, the auto-labeling for DVS frames is needed.

Currently, there are two auto-labeling approaches for DVS frame. One is to play a conventional camera video on a screen of a displaying monitor and use a DVS to record the screen. Another is, using deep learning model to directly generate labeled DVS frames from camera frames. However, these two approaches are both with insurmountable drawbacks. The first approach, loses precision, as when recording, it is hard to match 100% of the DVS frame exactly to the displaying monitor. The second approach will generate DVS frames which are unnatural. The reflection rate is different for different materials. But the second approach treats them the same because the DVS frames are generated directly from camera frames, which thus makes the generated DVS frames very unnatural. What's more, both approaches do not use a DVS to record a real scene, and will fall into problems of wasting the advantages of DVS, because the quality of camera video limits the final output of the generated DVS frames from the following aspect. First, the generated DVS frame rate would only reach the camera frame rate at most (although the second method could use up-scaling method to get more frames, but still, not promising). Second, the motion blur, after-image and smear, recorded by the camera, would also exist in the generated DVS frame. This fact is absurd and ridiculous, because the DVS is known for low-latency and no motion blur. Third, the high dynamic range of DVS is wasted, because conventional camera has low dynamic range.

Therefore, it is necessary to provide improved techniques to auto-label the DVS frame so as to quickly produce labeled DVS datasets at the same time the advantages of DVS is sufficiently adopted.

### SUMMARY

According to one or more embodiments of the disclosure, a method for auto-labeling dynamic vision sensor (DVS) frame is provided. The method may comprise generating a plurality of first frames in a first time period via a DVS which is recording a real scene, wherein light is supplemented to an area where the DVS is recording, in the first time period. The method may comprise applying a deep leaning model to at least one of the plurality of first frames to obtain at least one first detection result. Further, the method may comprise generating a plurality of second frames in a second time period via the DVS, wherein no light is supplemented to the area where the DVS is recording, in the second time period. The method may further comprise utilizing one of the at least one first detection result as a detection result for at least one of the plurality of second frames to generate at least one auto-labeled DVS frame.

According to one or more embodiments of the disclosure, a system for auto-labeling dynamic vision sensor (DVS) frame is provided. The system may comprise a DVS, a light generator and a computing device. The DVS may be configured to record a real scene, and generate a plurality of first frames in a first time period and generate a plurality of second frames in a second time period. The light generator may be configured to supplement light at intervals to an area where the DVS is recording, wherein the light generator may be configured to automatically emit light to an area where the DVS is recording, in the first time period, and the light generator may be configured to automatically stop emitting light to the area where the DVS is recording, in the second time period. The computing device may comprise a processor and a memory unit storing instructions executable by the processor to: apply a deep leaning model to at least one of the plurality of first frames to obtain at least one first detection result; and utilize one of the at least one first detection result as a detection result for at least one of the plurality of second frames to generate at least one auto-labeled DVS frame.

### BRIEF DESCRIPTION OF THE DRAWINGS

FIG. 1 illustrates a schematic diagram of the system in accordance with one or more embodiments of the present disclosure;

FIGS. 2-4 illustrate comparison examples of normal DVS frames and light-implemented DVS frames generated by the DVS in accordance with one or more embodiments of the present disclosure;

FIG. 5 illustrates the auto-labeling on light-supplemented DVS frames of FIG. 4;

FIG. 6 illustrates a plot as an example to show an operation of the light generator;

FIG. 7 illustrates a method flowchart in accordance with one or more embodiments of the present disclosure; and

FIG. 8 illustrates an example of the auto-labeled normal DVS frames in accordance with one or more embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION OF THE PREFERRED EMBODIMENTS

Examples will be provided below for illustration. The descriptions of the various examples will be presented for purposes of illustration, but are not intended to be exhaustive or limited to the embodiments. Many modifications and variations will be apparent to those of ordinary skill in the art without departing from the scope and spirit of the described embodiments.

In general, the present disclosure provides a system and a method of auto-labeling the DVS frames by using the existing camera deep learning models. By combining a light generator and a DVS together to supplement light to the place where the DVS is recording, the DVS could generate frames in a manner that conventional camera would do and thus light-supplemented DVS frames which perform like conventional camera frames would be generated. Since the deep learning models in conventional camera area are already well-developed and mature, it is possible to use the detection results on camera frames to automatically label the DVS frames, as long as the DVS frames are pixel-level matched to the camera frames. By supplementing lights, the generated light-supplemented DVS frames perform like conventional camera frames. Thus, the existing deep learning models of conventional cameras could also be applied on the light-supplemented DVS frames to get detection results. Immediately following the generation of light-supplemented DVS frames, the normal DVS frames may be generated by the DVS with the light generator turning off. The detection results on the light-supplemented DVS frames may be used as detection results on the normal DVS frames so as to generate the auto-labeled DVS frames. In this manner, the labeled DVS datasets may be quickly produced while the DVS is recording, which greatly improves efficiency for auto-labeling. In addition, the method and the system of the present disclosure is performed directly on the DVS frames generated by the DVS which is performing recording in a real scene, thus the advantages of DVS itself may be more effectively used.

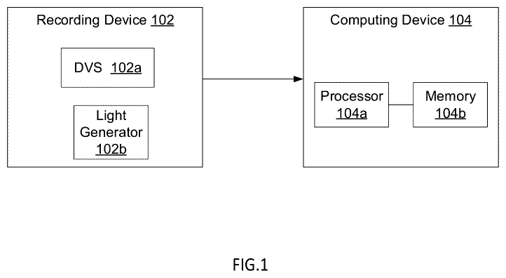

FIG. 1 illustrates a schematic diagram of a system for auto-labeling DVS frames in accordance with one or more embodiments of the present disclosure. As shown in FIG. 1, the system may comprise a recording device 102 and a computer device 104. The recording device 102 may at least include, with no limitation, a DVS 102a and a light generator 102b. The computing device 104 may include, without limitation, a processor 104a and a memory unit 104b.

The DVS 102a may adopt an event-driven approach to capture dynamic changes in a scene and then create asynchronous pixels. Unlike the conventional camera, the DVS generates no images, but transmits pixel-level events. When there is a dynamic change in the real scene, the DVS will produce some pixel-level output (that is, an event). Thus, if there is no change, then there would be no data output. The event data is in form of [x,y,t,p], in which x and y represents the coordinates of the pixels of the event in the 2D space, t is a time stamp of the event, and p is the polarity of the event. For example, the polarity of the event may represent a brightness change of the scene, such as becoming brighter or darker.

The light generator 102b may be any device that could supplement lights to the place where the DVS is recording. The light emitted from the light generator 102b may comprise any of infrared light, ultraviolet light, illumination light visible to the human eye, and so on. A preferred example would be IR LED fill lights, which is usually used together with IR camera. The DVS 102a and the light generator 102b may be rigidly or detachably combined/assembled/integrated together. It should be understand that FIG. 1 is only to illustrate the components of the system, and is not intended to limit the positional relationship of system components. The DVS 102a can be arranged in any relative position relation with the light generator 102b as long as the light generator 102b can supplement light to the area where the DVS 102a is recording.

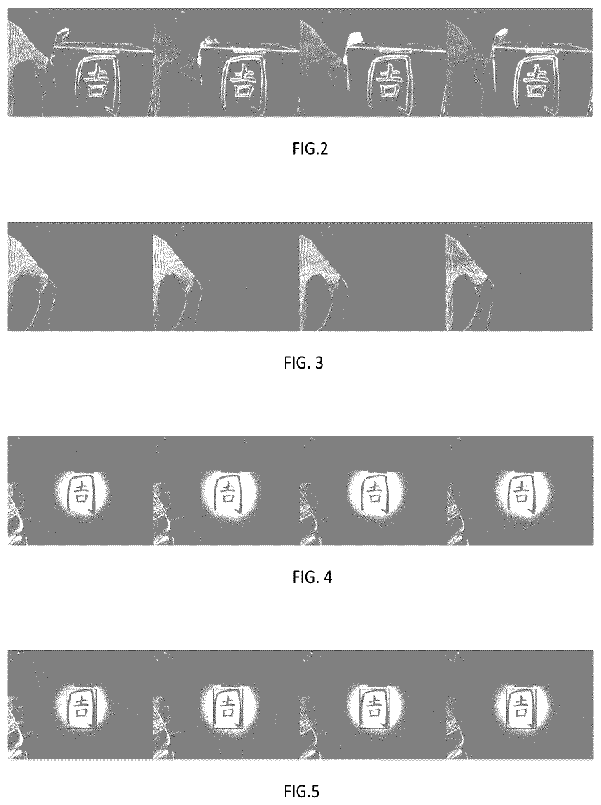

The combined use of the DVS and the light generator comes from the inventor's important discovery in the process of developing auto-labeling DVS frames. The inventor discovered a surprising phenomenon that has not been recognized by those of ordinary skilled in the art, that is, supplementing light to the area where the DVS is recording can obtain unexpected effects on the generated DVS frames. FIGS. 2-4 show comparison examples of generated DVS frames with different conditions in a scene wherein the main target is a box with a Chinese name painting on the box. FIG. 2 illustrates an example of the generated DVS frames in the case of adding a disturbance to the box. It can be seen that the DVS could capture the box and the name in this case. On the contrary, FIG. 3 illustrates an example of the generated DVS frames without any disturbance to the box, which shows the DVS would not capture the box and the name. FIG. 4 illustrates an example of the generated DVS frames with extra lights (e.g., IR LED lights emitting from a light generator) on the box. FIG. 4 shows that the DVS could capture the name painting on the box in the case that light is supplemented to the part of the area where the DVS is recording, wherein the circle portion indicates the part of area of supplemented lights. The comparison examples of FIGS. 2-4 illustrate when the area being recorded by the DVS is supplemented with light, the imaging of the DVS is closer to the result of the camera imaging and the generated light-supplemented DVS frame performs like a gray scale camera image. Although in principle, supplementing light will defeat the purpose of DVS in a certain sense, the comparison examples showed in FIGS. 2-4 can fully prove the result, that is, by supplementing light, the ‘light-supplemented’ DVS frames which perform like conventional camera frames would be generated. FIG. 5 illustrates detection results on the light-supplemented frames of FIG. 4, using the existing deep leaning model, such as a character detection model.

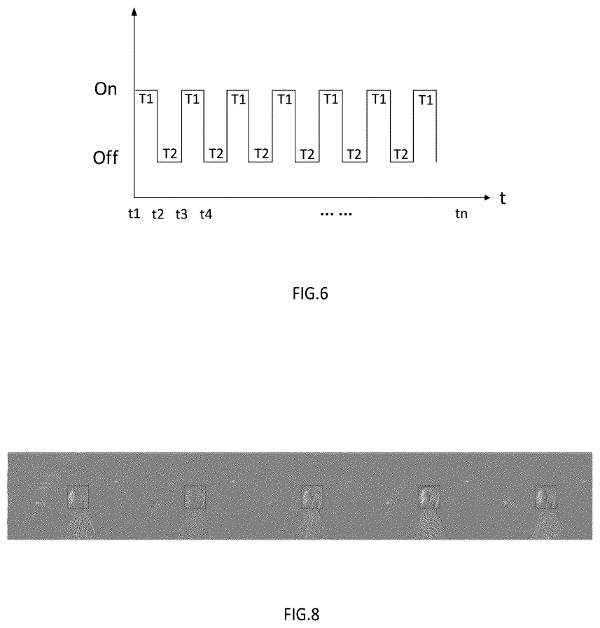

According to one or more embodiments of the present disclosure, the light generator 102b may be controlled by manual or may be controlled automatically to switch between turning-on and turning-off alternatively, and thus may emit light at intervals. FIG. 6 illustrates a plot as an example to show an automatic operation of the light generator 102b. For example, at time t1, the light generator 102b turns on and emits light to an area where the DVS 102a is recording. At time t2, the light generator 102b automatically turns off and no light will be supplemented to the area where the DVS 102 is recording. At time t3, the light generator 102b automatically turns on and emits light to an area where the DVS 102a is recording. At time t4, the light generator 102b automatically turns off and no light will be supplemented to the area where the DVS 102 is recording. According to the practical requirement, the light generator may automatically repeat the above operations until an end time tn.

Next, the combined operation of the DVS 102a and the light generator 102b will be described. The system for auto-labeling DVS frames may be positioned in an environment for recording a real scene. The DVS 102a is configured to record the real scene. As described above, the light generator 102b may be controlled by manual or may be controlled automatically to switch between turning-on and turning-off alternatively. For example, at time t1, the light generator 102b turns on and emits light to an area where the DVS 102a is recording. At time t2, the light generator 102b turns off. During a first time period (T1) from t1 to t2, as the light being supplemented, the DVS 102a would generate frames in a manner that conventional camera would do. As described as above, it could be expected to generate something like a gray scale camera image, but actually is recorded by DVS. Thus, as the light being supplemented, the DVS 102a may generate a plurality of frames in the first time period, i.e., light-supplemented DVS frames. Upon the first time period T1 expires, for example at time t2, the light generator automatically turns off (i.e., stops emitting light), then the DVS 102a performs as it normally do and generates a plurality of normal DVS frames in the second time period (T2) until the next time t3 at which the light generator automatically turns on again. And so on. The first time period T1 and the second period T2 are interlaced. For example, the time periods T1 and T2 may be in the order of milliseconds. According to the practical need, the first time period T1 and the second period T2 may be the same or different. FIG. 6 is only for illustration but not to limit the parameter values of the time periods.

Back to FIG. 1, the computing device 104 may be any form of devices that can perform computation, including without limitation, a mobile device, a smart device, a laptop computer, a tablet computer, an in-vehicle navigation system and so on. The computing device 104 may include, without limitation, a processor 104a and a memory unit 104b. The processor 104a may be any technically feasible hardware unit configured to process data and execute software applications, including without limitation, a central processing unit (CPU), a microcontroller unit (MCU), an application specific integrated circuit (ASIC), a digital signal processor (DSP) chip and so forth. The computing device 104 may include, without limitation, and a memory unit 104b for storing data, code, instruction, etc., executable by the processor. The memory unit 104b may include, without limitation, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

According to one or more embodiments, the processor 104a may perform auto-labeling of the DVS frames. In particular, the processor 104a may be configured to receive the light-supplemented DVS frames and the normal DVS frames generated by the DVS, and apply any existing deep leaning model for conventional cameras to the light-supplemented DVS frames to obtain a first detection result, and then uses one of the first detection results as a detection result for at least one of the plurality of second frames to generate at least one auto-labeled DVS frame. The labeled DVS datasets including the labeled DVS frames may be stored in the memory 104b.

Since the DVS is of extreme low latency (in unit of ‘us’), the light supplementing process could be limited to a very short time period, i.e., the first time period could be limited to a very short time, such as several milliseconds. Thus, the time gap between the ‘light-supplemented’ DVS frames and the afterwards normal frames (real scene) DVS frames could be neglected. As a result, these two kinds of frames are actually depicting the same scenes. Thus, the processor 104a may be configured to use one of the obtained first detection results on at least one light-supplemented DVS frames as a detection result for at least one of normal DVS frames to generate at least one auto-labeled DVS frame.

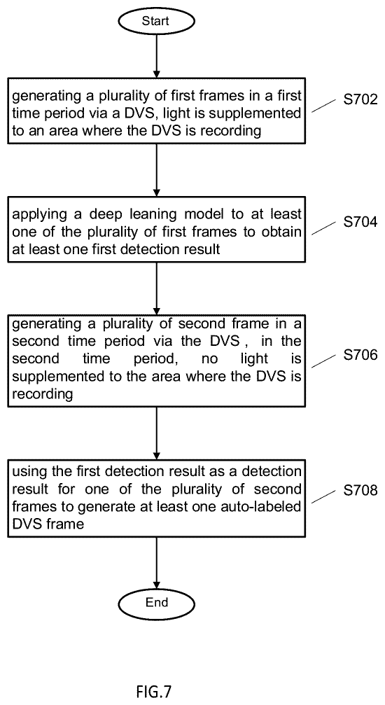

FIG. 7 illustrates a method flowchart in reference to the system shown in FIG. 1 in accordance with one or more embodiments of the present disclosure. As shown in FIG. 7, at S702, the DVS that is recording a real scene generates a plurality of first frames in a first time period, wherein in the first time period, light is supplemented to an area (e.g., a whole area or a part of the area) where the DVS is recording. At S704, a deep leaning model is applied to at least one of the plurality of first frames to obtain at least one first detection result. For example, at least one frame may be selected from the first frames as an input of a deep learning model. Then, the at least one detection result may be determined based on the output of the deep leaning model. For example, the at least one first detection result may comprise data regarding an identified object and an object area for auto-labeling. At S706, the DVS generates a plurality of second frames in a second time period, wherein no light is supplemented to the area where the DVS is recording, in the second time period. The first time period and the second time period may be interlaced. For example, the first time period and the second time period may be in the order of milliseconds. At S708, one of the at least one first detection result may be used as a detection result for at least one of the plurality of second frames to generate at least one auto-labeled DVS frame. By using the above method of auto-labeling, at least one light-supplemented frame could be used to label many normal DVS frames because of the extreme low latency of DVS, which may further improve the efficiency of auto-labeling.

FIG. 8 shows an example of auto-labeled normal DVS frames for an example scene using the method and system of the present disclosure, wherein these auto-labeled normal DVS frames are consecutive frames. In this scene, for example, a head detection may be applied on one of the light-supplemented DVS frames.

The method and system described in the present disclosure may realize more efficient automatic labeling of DVS frames. This innovation proposes a method of auto-labeling the DVS frames by using the existing camera deep learning models. A light supplement-er is being used, to make ‘light-supplemented’ DVS frames which perform like conventional camera frames. Based on the combined use of the light-supplemented frames and the normal DVS frames, the DVS frames can be labeled automatically while at the same time they are recording. As a result, huge amount of labeled data for DVS deep learning training would be possible. In this manner, the labeled DVS datasets may be quickly produced while the DVS is recording, which greatly improves efficiency for auto-labeling. In addition, compared with the existing approach, the method and the system of the present disclosure is performed directly on the DVS frames generated by the DVS which is performing recording a real scene, thus the advantages of DVS itself may be used more effectively.

1. In some embodiments, a method for auto-labeling dynamic vision sensor (DVS) frames, the method comprising: generating a plurality of first frames in a first time period via a DVS which is recording a real scene, wherein light is supplemented to an area where the DVS is recording, in the first time period; applying a deep leaning model to at least one of the plurality of first frames to obtain at least one first detection result; generating a plurality of second frames in a second time period via the DVS, wherein no light is supplemented to the area where the DVS is recording, in the second time period; and utilizing one of the at least one first detection result as a detection result for at least one of the plurality of second frames to generate at least one auto-labeled DVS frame.

2. The method according to clause 1, further comprising: wherein the light is supplemented by a light generator which is arranged to combine with the DVS and emit light at intervals.

3. The method according to any one of clauses 1-2, wherein the first time period and the second time period are interlaced and are in the order of milliseconds.

4. The method according to any one of clauses 1-3, wherein the at least one first detection result comprises an identified object and an object area for auto-labeling.

5. The method according to any one of clauses 1-4, wherein the light is supplemented to a whole or a part of the area where the DVS is recording.

6. The method according to any one of clauses 1-5, wherein applying a deep leaning model to at least one of the plurality of first frames comprising: selecting one frame from the first frames as an input of a deep learning model, and determining the detection result based on the output of the deep leaning model.

7. In some embodiments, a system for auto-labeling dynamic vision sensor (DVS) frames comprising: a DVS configured to record a real scene, and generate a plurality of first frames in a first time period and generate a plurality of second frames in a second time period; a light generator configured to supplement light at intervals to an area where the DVS is recording, wherein the light generator automatically emits light to an area where the DVS is recording, in the first time period, and the light generator automatically stops emitting light to the area where the DVS is recording, in the second time period; and a computing device comprising a processor and a memory unit storing instructions executable by the processor to: apply a deep leaning model to at least one of the plurality of first frames to obtain at least one first detection result; and utilize one of the at least one first detection result as a detection result for at least one of the plurality of second frames to generate at least one auto-labeled DVS frame.

8. The system according to clause 7, wherein the first time period and the second time period are interlaced and are in the order of milliseconds.

9. The system according to any one of clauses 7-8, wherein the at least one first detection result comprises an identified object and an object area for auto-labeling.

10. The system according to any one of claims 7-9, wherein the light generator is configured to emit light to a whole or a part of area where the DVS is recording.

11. The system according to any one of claims 7-10, wherein the processor is further configured to: select one camera frame from the pair of camera frames as an input of a deep learning model, and determine an object area for auto-labeling based on the output of the deep leaning model.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference sign is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

While the foregoing is directed to embodiments of the present disclosure, other and further embodiments of the disclosure may be devised without departing from the basic scope thereof, and the scope thereof is determined by the claims that follow.

1. A method for auto-labeling dynamic vision sensor (DVS) frames, the method comprising:
generating a plurality of first frames in a first time period via a DVS which is recording a real scene, wherein light is supplemented to an area where the DVS is recording, in the first time period;
applying a deep leaning model to at least one of the plurality of first frames to obtain at least one first detection result;
generating a plurality of second frames in a second time period via the DVS, wherein no light is supplemented to the area where the DVS is recording, in the second time period; and
utilizing one of the at least one first detection result as a detection result for at least one of the plurality of second frames to generate at least one auto-labeled DVS frame.

2. The method according to claim 1, wherein the light is supplemented by a light generator which is arranged to combine with the DVS and emit light at intervals.

3. The method according to claim 1, wherein the first time period and the second time period are interlaced and are in the order of milliseconds.

4. The method according to claim 1, wherein the at least one first detection result comprises an identified object and an object area for auto-labeling.

5. The method according to claim 1, wherein the light is supplemented to a whole or a part of the area where the DVS is recording.

6. The method according to claim 1, wherein applying a deep leaning model to at least one of the plurality of first frames comprising:
selecting one frame from the first frames as an input of a deep learning model, and
determining the detection result based on the output of the deep leaning model.

7. A system for auto-labeling dynamic vision sensor (DVS) frames comprising:
a DVS configured to record a real scene, and generate a plurality of first frames in a first time period and generate a plurality of second frames in a second time period;
a light generator configured to supplement light at intervals to an area where the DVS is recording, wherein the light generator automatically emits light to an area where the DVS is recording, in the first time period, and the light generator automatically stops emitting light to the area where the DVS is recording, in the second time period; and
a computing device comprising a processor and a memory unit storing instructions executable by the processor to:
apply a deep leaning model to at least one of the plurality of first frames to obtain at least one first detection result; and
utilize one of the at least one first detection result as a detection result for at least one of the plurality of second frames to generate at least one auto-labeled DVS frame.

8. The system according to claim 7, wherein the first time period and the second time period are interlaced and are in the order of milliseconds.

9. The system according to claim 7, wherein the at least one first detection result comprises an identified object and an object area for auto-labeling.

10. The system according to claim 7, wherein the light generator is configured to emit light to a whole or a part of area where the DVS is recording.

11. The system according to claim 7, wherein the processor is further configured to select one frame from the first frames as an input of a deep learning model, and determine the detection result based on the output of the deep leaning model.
